(19) United States
(12) Patent Application Publication
(10) Pub. No.: US 2012/0231197 A1
(43) Pub. Date: Sep. 13, 2012

(54) RELEASE LINER FOR LABEL LAMINATE

(75) Inventor: Noel Mitchell, Wuppertal (DE)

(73) Assignee: UPM RAFLATAC OY, Tampere (FI)

(21) Appl. No.: 13/508,639

(22) PCT Filed: Nov. 9, 2010
(86) PCT No.: PCT/FI10/50903

§ 371 Date: May 8, 2012

Related U.S. Application Data
(60) Provisional application No. 61/259,262, filed on Nov. 9, 2009.
(60) Provisional application No. 61/320,396, filed on Apr. 2, 2010.

(51) Int. Cl. B32B 7/06; B05D 5/00; B05D 3/02

(52) U.S. Cl. 428/40.2; 427/543; 428/41.8

(57) ABSTRACT

A method of preparing a release layer of a release liner for a label laminate. A substantially continuous release layer with controlled thickness is formed on a liner substrate from a composition including at least a release agent and an inductive filler material. The release layer is heated to cure the release agent. The heating is at least partly based on electromagnetic induction heating of the inductive filler material. Also a release liner and a label laminate.

### FIELD OF THE INVENTION

The present invention relates to label laminates. More specifically, the invention relates to a release liner of a label laminate, and to a method for manufacturing it.

### BACKGROUND OF THE INVENTION

Pressure sensitive label laminates, also called as self adhesive label laminates, are well known in the art. Typical construction of these laminates consists of a release liner and a face stock material which are laminated together with a pressure sensitive adhesive (PSA) layer in between. Release liner may have e.g. polymeric film or paper as a backing material, which backing material is coated with a release agent such as silicone. Conventional silicone release coating systems consists of a reactive silicone compound, a cross-linker, a catalyst, and optionally an inhibitor. After coating to the backing material the silicone layer is further dried and cured at activating tunnel with an elevated temperature to achieve a cross-linked silicone release layer. Subsequently the release liner or a face stock material is coated with an adhesive, which is dried under heat at drying tunnel, to form a pressure sensitive adhesive layer. The face stock and backing paper are further laminated together to form a label laminate. In the label laminate an adhesive layer is against the siliconised side of the backing material, which provides a nonadherent surface and low adhesion release effect against the adhesive layer. Due to the release characteristics of the silicon layer, the release liner can be easily removed to expose the pressure sensitive adhesive upon application of the label onto an item to be labeled.

One disadvantage of the manufacturing of the release liner is that the silicone coating needs quite a long curing time and high curing temperature. Thus this conventional thermal curing process is both time and energy consuming process. Another disadvantage is that the backing material also becomes heated up, which sets further requirements for the backing material, such as strength and dimensional stability. Silikonizing polymeric liners is especially challenging, for example because of their low resistance to high temperatures. In the point of view of cost efficiency also thinner backing material films or materials with lower performance or properties would be preferred. These kinds of materials are even more sensitive for the heating and may lead to runnability problems in the subsequent lamination process.

### SUMMARY OF THE INVENTION

It is an object of the present invention to provide a release liner for a label laminate, which release liner comprises a multi-component release layer. It is another object to provide a method for producing said release liner. It is yet another object to provide an improved method for curing a release layer of said release liner.

According to a first aspect of the present invention there is provided a method for producing a release layer of a release liner for a label laminate, the method comprising:
forming a substantially continuous release layer with controlled thickness on a liner substrate from a composition comprising at least a release agent and an inductive filler material;
heating the release layer to cure the release agent, wherein the heating is at least partly based on electromagnetic induction heating of the inductive filler material.

According to a second aspect of the present invention there is provided a release liner for a label laminate. The release liner consists of a substantially continuous release layer with controlled thickness on a liner substrate. The release layer has a composition comprising at least a release agent and an inductive filler material.

According to a third aspect of the present invention there is provided a use of a release liner for pressure sensitive label laminates.

According to a fourth aspect of the present invention there is provided a label laminate comprising a face stock material, an adhesive layer and a release liner with a release layer on a liner substrate. The release layer has a composition comprising at least a release agent and an inductive filler material. The release agent is at least partly cured by electromagnetic induction heating.

Further embodiments are presented in the dependent claims.

In an embodiment, the release layer composition contains an inhibitor system. The inhibitor system is deactivatable and may thus be deactivated by deactivation step. The deactivation step may be performed simultaneously with or before the electromagnetic induction heating. The deactivation step may include using an ultraviolet radiation.

The release layer may comprise silicone.

The release agent of the release layer is at least partly curable by electromagnetic heating of the inductive filler material. The release agent may be also curable with one or more heating methods.

In an embodiment, the electromagnetic heating may be combined with one or more additional heating methods based on radiative or convective heating or combination of those.

The inductive filler material may be a metallic, ferromagnetic, ferrimagnetic, paramagnetic or superparamagnetic material or a combination of two or more of said materials. The inductive filler material may comprise particles and/or fibres.

In an embodiment, the release layer may have a multilayered structure comprising at least two different layers having different compositions.

The inductive filler material may be arranged homogeneously or non-homogeneously to at least one of the layers of the release layer. The release layer having multilayered structure may comprise both homogeneous and/or non-homogeneous layers.

### DESCRIPTION OF THE DRAWINGS

In the following, the embodiments of the invention will be discussed in more detail with reference to accompanying figures, where

FIG. 1 shows, in a cross-sectional view, a label laminate structure,

FIG. 2 shows, in a cross-sectional view, a release agent layer,

FIG. 3 shows, in a cross-sectional view, a release liner according to one example embodiment of the invention,

FIG. 4 shows, in a cross-sectional view, a release liner according to another example embodiment of the invention, and

FIG. 5 shows, in cross-sectional view, a release liner according to still another example embodiment of the invention.

### DETAILED DESCRIPTION OF THE INVENTION

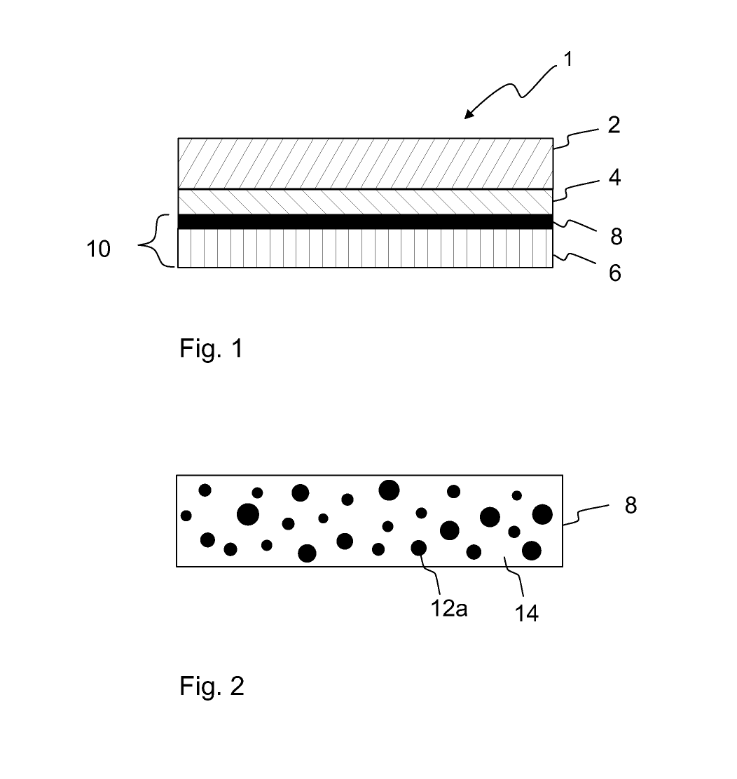

Referring to the FIG. 1, a label laminate 1 may comprise a face stock material 2, an adhesive layer 4, a backing material 6, and a release layer 8. The backing material may also be called as a carrier or liner substrate. The release layer comprises a release agent. The release agent may be, but is not limited to, one-part or two part silicone systems. The release agent may be heat curable. The release agent is coated on to the surface of a liner substrate 6 to form a release layer 8. Based on the coating process applied, the silicone coating compositions may be solvent-based, emulsion-based or solventless (100% solid composition). The liner substrate 6 and the release layer 8 together form a release liner 10 for the label laminate 1. Silicone coated liner substrates may be referred to as siliconized release liners or silicone coated release liners. The backing material for the release liner may be paper or polymeric film, such as polyethylene, polypropylene or polyester.

After being applied to the liner substrate, silicone coatings must be cured to cross-link the silicone polymer chains and to form a three-dimensional release agent network, such as polydimethylsiloxane (PDMS) network. A silicone curing, cure chemistry reaction and/or cross-linking of reactive silicones, may be achieved partly or substantially totally by means of induction heating in situ in the release layer 8, e.g. the silicone layer, instead of conventional curing processes. During conventional curing process the thermal energy is brought into said release agent layer from outside by means of thermal convection and/or radiation in a heating tunnel.

Induction heating allows the targeted heating of the release agent layer 8 of the release liner 10. The time and energy needed for the release layer curing process may be reduced when the heat is focused better and more precisely only into the release layer itself, e.g. the silicone layer. Selective heating of the release layer may also facilitate more homogeneous curing of the release agent and help to reduce the heat conduction into the backing substrate material, such as thermally sensitive polymeric film. Reduced curing time and selective heating may further wider the range of materials suitable for the backing materials. For example, more heat-sensitive and/or lower quality materials may be used.

Induction heating is the process of heating an electrically conducting object, in this case the release layer 8, by electromagnetic induction, where eddy currents are generated within the material and the ohmic resistance of the material leads to Joule heating of said material. Heat may also be generated by magnetic hysteresis losses in material in case it has significant relative permeability. The frequency of electromagnetic field used for heating depends on the object size, material type, coupling efficiency and the electromagnetic field penetration depth.

Referring to FIG. 2, the release layer 8, e.g. silicone layer, has a composition which is capable of being heated and/or cured i.e. cross-linked by means of electric induction when an electromagnetic field is applied. In order to arrange the release layer suitable to be inductively heated, the release agent 14, also called as a release agent matrix or material, of a release layer is blended with filler material 12, such as filler particles 12a which have, for example, ferromagnetic, ferrimagnetic, paramagnetic or superparamagnetic properties. In the following, these materials and particles are called shortly as inductive materials or inductive filler particles respectively. Such inductive filler materials 12 may comprise metallic or composite fibres and/or particles, which may also be a size of a nanoscale. The release agent material or release layer comprising inductive filler material may be called as a multi-component release agent material or a multi-component release layer respectively.

Inductive filler material 12 may be substantially homogeneously arranged to at least one of the layers of the release layer 8. For example, inductive filler particles 12a may be substantially homogeneously dispersed in the release agent matrix 14 of the release layer 8. Consequently, the release layer 8 may be substantially homogeneously filled with filler particles. Thus the heating also takes place substantially homogeneously throughout the release layer 8.

Alternatively, it is possible that the inductive filler material 12 is arranged heterogeneously (non-homogeneously) to at least one of the layers of the release layer (8). For example, inductive filler particles 12a may be heterogeneously dispersed in the release agent matrix 14 of the release layer 8. Consequently, the release layer 8 is loaded (filled) with the inductive filler particles 12a in non-homogeneous manner e.g. in the machine or cross-machine directions of the release liner web. In other words, the release layer 8 contains only stripes or rectangles or other shaped areas oriented in machine and/or cross-machine direction so that part of the release layer area is loaded less or perhaps not loaded at all by the filler particles. Again, this embodiment can take use of the thermal conductivity to convey heat from the heavily loaded areas to the less loaded areas. In certain embodiments it may also be possible, that some parts of the release layer are not wished to become cured at all.

Alternatively, the inductive filler material may be arranged as a separate homogeneous or heterogeneous coating layer on top of the layer of release agent matrix 14.

As an example silicone or other corresponding release agent material may be blended or filled with MagSilica® (Evonik Industries, Germany) nanoparticles. MagSilica® particles behave superparamagnetically and particles can be heated by alternating electromagnetic fields.

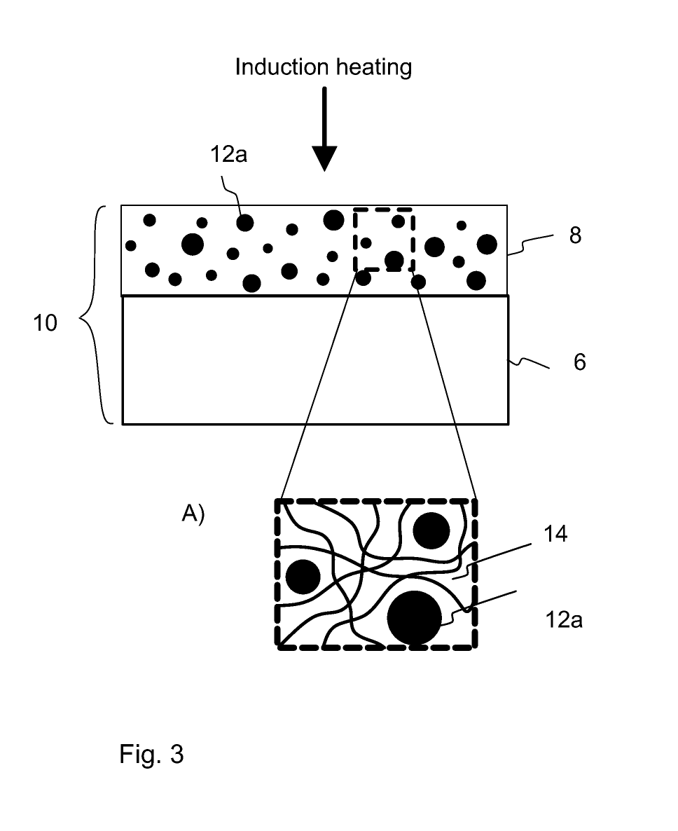

Referring to the FIG. 3, the release liner 10, consisting of a liner substrate 6 and a release layer 8 including an electrically conductive and/or magnetic filler particles 12a, is inductively heated by electromagnetic induction. As shown in point A), which is a partial enlargement of the release layer 8, during induction heating of the release liner these inductive filler particles 12a become heated up, which in turn heats up and thus cures and cross-links the surrounding release agent matrix 14, such as silicone.

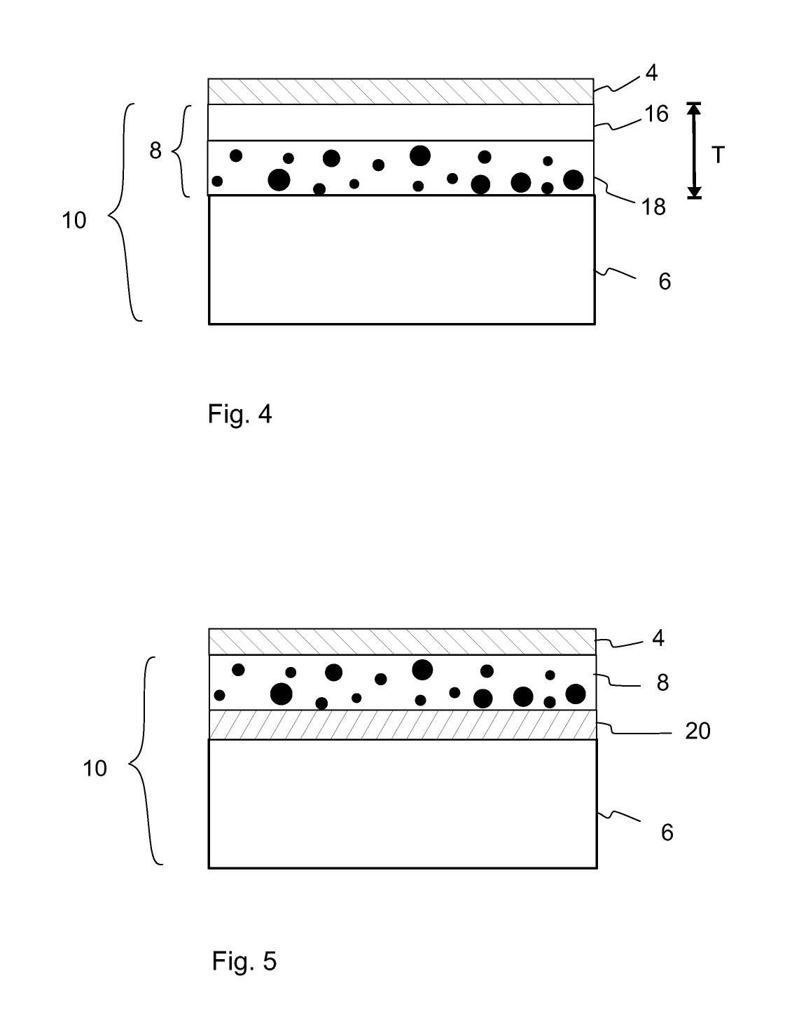

Referring to the FIG. 4, the release layer 8 is formed of at least two different layers 16,18, superimposed in the thickness direction T of the material, so that these at least two different layers have different amount of inductive filler material in them. Thus the release layer 8 may have a multilayer structure. For example, it is possible that one of the layers 16 is left completely without the inductive filler particles in order not to affect the adhesion properties of that layer. This layer could be, for example, the layer directly next to the pressure sensitive adhesive layer 4. In this case when the other release layer(s) next to this layer become inductively heated, they heat up also this nearby layer via thermal conductivity of the material. The amount of inductive filler particles in each of layers can be selected freely depending on the application. The multilayered structure of a release layer may also comprise separate layers where the dispersion of the filler material is different i.e. homogeneous or non-homogeneous.

Referring to the FIG. 5, one or more barrier layers 20 are used in the structure of the release liner 10 to control the amount of the thermal conductivity from the one or more inductively heated layers to other neighbouring layers.

A method for preparing a release layer 8 of a release liner 10 for label laminate 1 may comprise at least the following steps:
forming a substantially continuous release layer 8 with controlled thickness on a liner substrate 6 from a composition (mixture) comprising at least release agent 14 and inductive filler material 12;
heating the release layer 8 to cure the release agent 14, wherein the heating is at least partly based on electromagnetic induction heating of the inductive filler material 12.

The release layer 8 may be applied by using conventional coating methods, such as six-roll coating.

In an embodiment, the release layer composition may further include inhibitor(s). Different type of cure inhibitors may be used in release agent composition, e.g. silicone compositions, to control the curing of the release agent so that curing takes place in a preferred manner and at preferred time. For example, any suitable heat or radiation deactivatable inhibitor systems known in the art may be used. The inhibitor system may be added to any part or location of the release agent layer(s), e.g. silicone layer or layers.

Basic heat deactivated cure inhibitors are compounds which slow curing of the coating mixture at ambient temperatures or prevent premature cure at room temperature but do not retard curing at elevated temperatures. This can be used, for example, to extend the usable pot life of the compositions. Radiation deactivated inhibitor systems can be deactivated by irradiating the release agent compound typically with UV light. This deactivates the inhibitor system and then allows thermal curing to take place. Thus, UV deactivation can be used to trigger the release agent composition e.g. silicone from non-curable to curable state.

In an embodiment, the method may further involve a deactivation step of the inhibitor system comprised in the release agent material, e.g. the silicone composition, in order to improve the efficiency of the curing, cure chemistry reactions and/or cross-linking. Consequently faster curing and higher coating speeds may be achieved.

Preferably the deactivation of the inhibitor system may take place before the induction heating phase but it is possible also to have the deactivation and induction heating phases to be arranged overlappingly i.e. simultaneously respect to each other.

For example, the silicone-coated release liner may be irradiated preferably at least partly by use of ultraviolet (UV radiation), which irradiation deactivates the inhibitor system of the silicone. Especially, any UV radiation wavelength suitable for deactivating such inhibitors may be used in pulsed or continuous radiation and in one or more places along the production (web) line. The UV radiation sources may be narrow wavelength band (narrow spectra) emitters or wide wavelength band (wide spectra) emitters and limited to only UV wavelength radiation or emitting in addition to UV wavelengths also visible and/or infrared wavelengths. The infrared wavelengths of the radiation sources may be used to additionally thermally heat the silicone layer(s).

The suitable UV emitters may include, but are not limited to, for example halogen lamps, xenon lamps and other gas discharge lamps, gas based lasers, crystal based laser and semi-conductor based (diode) lasers. Wavelength range can be, for example, from 200 nm-400 nm.

In an embodiment, only part of the thermal energy required to cure and/or cross-link the release agent layer is brought inductively into the material. Traditional convective or radiative heating can be used in addition to inductive heating either before, overlapping or after the inductive heating phase. For example the silicone layer may be cured, in addition to induction heating, also by other mechanisms such as moisture-curing, heat-curing, photoinitiated curing by e.g. ultraviolet, or any combination of different mechanisms.

The inductive filler material may also alter the transparency of the release agent layer. Many inductive filler materials have dark or brownish colour which makes a material loaded with those particles highly absorbent for near infrared or infrared heat radiation. This allows using thermal radiation from an infrared heat source to radiatively heat up the material. Optimally, the wavelength range of the infrared radiation is tuned to match the maximum absorption wavelengths of the filler loaded material. Thus, one embodiment of the invention is to combine inductive heating together with thermal radiative heating to cure and/or cross-link the inductive particle loaded release agent layer. For this embodiment, an inductive filler material with high near infrared or infrared absorption properties (e.g. dark color) should be selected.

In order to adjust the heating properties of the release agent layer or layers, the amount of the inductive filler material can be selected according to the need. In addition to this, the temporal duration as well as the physical length of the inductive heaters in the machine direction of the release liner web can be varied. The heating may also be accomplished in pulsed manner where heating periods follows cooling (and heat spreading) periods with a certain frequency. There may also be more than one inductive heaters arranged in successive manner along the machine direction with non-heated web regions in between, or with additional radiative and/or convective heating regions arranged therein.

The frequency of the electromagnetic field can be selected to suit the material to be heated and in order to have a suitable field (and heat) penetration depth.

This invention is in principle usable in any applications the material needs to be dried and/or cured and/or cross-linked, such as a release agent of a release liner for pressure sensitive label laminates. The release liner may be used also with other applications like adhesive tapes or films.

With this invention, it is expected to achieve more efficient and economic curing process of a silicone or corresponding release agent of a release liner compared to conventional processes. It is also expected to be possible to construct more compact and energy effective manufacturing lines to produce release liners. The combination of accurately controllable induction heating with accurately controllable deactivation of the inhibitor system gives also possibility to tailor the release agent e.g. silicone curing and/or cross-linking for modern, highly demanding and sensitive materials of liner substrate.

The various aspects of the invention are illustrated by the following examples.

Example 1.1. A method of preparing a release layer of a release liner for a label laminate, wherein the preparation comprises the step of induction heating of the release agent comprised in that release layer.

Example 1.2. The method according to example 1.1, wherein prior to the induction heating inductive filler particles are added to the release agent.

Example 1.3. The method according to example 1.2, wherein the inductive filler particles are added homogenously to the release agent to cover homogenously the release layer.

Example 1.4. The method according to example 1.2, wherein the inductive filler particles are added non-homogenously to the release agent to cover non-homogenously the release layer.

Example 1.5. The method according to examples 1.1-1.4, wherein the inductive filler particles are metallic, ferromagnetic, ferrimagnetic, paramagnetic or superparamagnetic particles or a combination of two or more of said materials.

Example 1.6. The method according to examples 1.1-1.5, wherein the release agent comprises silicone.

Example 1.7. The method according to examples 1.1-1.6, wherein the step of induction heating is combined with one or more additional heating methods based on radiative or convective heating or a combination of those.

Example 2.1 A label laminate comprising a release liner with a release layer comprising a release agent, wherein the release layer comprises release agent at least partly prepared using induction heating.

Example 2.2. A label laminate according to example 2.1, wherein the release agent comprises silicon.

Example 2.3. A label laminate according to examples 2.1-2.2, wherein the release agent contains inductive filler particles.

Example 2.4. A label laminate according to examples 2.1-2.3, wherein the release agent contains metallic, ferromagnetic, ferrimagnetic, paramagnetic or superparamagnetic particles or a combination of two or more of said materials.

Example 2.5. A label laminate according to examples 2.1-2.4, wherein the inductive filler particles are arranged homogenously to the release agent to cover homogenously the release layer.

Example 2.6. A label laminate according to examples 2.1-2.5, wherein the inductive filler particles are arranged non-homogenously to the release agent to cover non-homogenously the release layer.

Example 2.7. A label laminate according to examples 2.1-2.6, wherein the release liner comprises two or more separate layers different in compositions.

Example 3.1 A method of preparing a release layer of a release liner for a label laminate, wherein the preparation comprises at least the steps of deactivation of the inhibitor system of the release agent and the step of induction heating of the release agent.

Example 3.2. The method according to example 3.1, wherein the deactivation is made using ultraviolet radiation.

Example 3.3. The method according to example 3.1, wherein the deactivation phase is arranged before the induction heating phase.

Example 3.4. The method according to example 3.1, wherein the deactivation phase is arranged overlappingly in time with the induction heating phase.

Example 3.5. The method according to example 3.1, wherein prior to the induction heating inductive filler particles are added to the release agent.

Example 3.6. The method according to example 3.5, wherein the inductive filler particles are added homogenously to the release agent to cover homogenously the release layer.

Example 3.7. The method according to example 3.5, wherein the inductive filler particles are added non-homogenously to the release agent to cover non-homogenously the release layer.

Example 3.8. The method according to examples 3.5-3.7, wherein the inductive filler particles are metallic, ferromagnetic, ferrimagnetic, paramagnetic or superparamagnetic particles or a combination of two or more of said materials.

Example 3.9. The method according to examples 3.1-3.8, wherein the release agent comprises silicone.

Example 4. The method according to examples 3.1-3.9 wherein the step of induction heating is combined with one or more additional heating methods based on radiative or convective heating or a combination of those.

Example 5.1 A label laminate comprising a release liner with a release layer, the release layer further comprising a release agent, wherein the release agent has been at least partly being prepared using induction heating overlappingly in time or after deactivation of the inhibitor system of the release agent.

Example 5.2. A label laminate according to claim 5.1, wherein the deactivation is made using ultraviolet radiation.

Example 5.3. A label laminate according to example 5.1, wherein the release agent comprises silicon.

Example 5.4. A label laminate according to examples 5.1-5.3, wherein the release agent contains inductive filler particles.

Example 5.5. A label laminate according to examples 5.1-5.4, wherein the release agent contains metallic, ferromagnetic, ferrimagnetic, paramagnetic or superparamagnetic particles or a combination of two or more of said materials.

Example 5.6. A label laminate according to examples 5.1-5.5, wherein the inductive filler particles are arranged homogenously to the release agent to cover homogenously the release layer.

Example 5.7. A label laminate according to examples 5.1-5.6, wherein the inductive filler particles are arranged non-homogenously to the release agent to cover non-homogenously the release layer.

Example 5.8. A label laminate according to examples 5.1-5.7, wherein the release liner comprises two or more separate layers different in compositions.

Example 6.1. Use of a silicone coated release liner in a label laminate, wherein the silicone is cured by induction heating of inductive filler particles added to the silicone.

Example 6.2. Use of a silicone coated release liner according to example 6.1, wherein the curing taking place overlappingly in time or after deactivation of the inhibitor system of the release agent.

The embodiments described above are only exemplary embodiments of the invention and a person skilled in the art recognizes readily that they may be combined in various ways to generate further embodiments without deviating from the basic underlying invention. The drawings are schematic. The particular embodiments described above with reference to the accompanying drawings are only illustrative and not meant to limit the scope of the invention, which is defined by the appended claims.

1. A method of preparing a release layer of a release liner for a label laminate, the method comprising:
forming a substantially continuous release layer with controlled thickness on a liner substrate from a composition comprising at least a release agent and an inductive filler material; and
heating the release layer to cure the release agent, wherein the heating is at least partly based on electromagnetic induction heating of the inductive filler material.

2. The method according to claim 1, wherein the inductive filler material comprises particles and/or fibers.

3. The method according to claim 2, wherein size of the particles and/or fibers is in nanoscale.

4. The method according to claim 1, wherein the inductive filler material is arranged homogeneously to at least one of the layers of the release layer.

5. The method according to claim 1, wherein the inductive filler material is arranged non-homogeneously to at least one of the layers of the release layer.

6. The method according to claim 1, wherein the inductive filler material is metallic, ferromagnetic, ferrimagnetic, paramagnetic or superparamagnetic material or a combination of two or more of said materials.

7. The method according to claim 1, wherein the release layer composition further contains an inhibitor system, the method further comprising:
deactivation of the inhibitor system.

8. The method according to claim 7, wherein the deactivation is performed simultaneously with or before the electromagnetic induction heating.

9. The method according to claim 7, wherein the deactivation includes using ultraviolet radiation.

10. The method according to claim 1, wherein the release layer is formed of at least two different layers having different compositions.

11. The method according to claim 1, wherein the release layer comprises silicone.

12. The method according to claim 1, wherein the electromagnetic induction heating is combined with one or more additional heating methods based on radiative or convective heating or combination of those.

13. A release liner for a label laminate, the release liner comprising:
a substantially continuous release layer with controlled thickness on a liner substrate from composition comprising at least a release agent and an inductive filler material.

14. The release liner according to claim 13, wherein the inductive filler material comprises particles and/or fibers.

15. The release liner according to claim 14, wherein a size of the particles and/or fibers is in nanoscale.

16. The release liner according to claim 13, wherein the inductive filler material is a metallic, ferromagnetic, ferrimagnetic, paramagnetic or superparamagnetic material or a combination of two or more of said materials.

17. The release liner according to claim 13, wherein the release layer further comprises an inhibitor.

18. The release liner according to claim 13, wherein the release layer comprises silicone.

19. The release liner according to claim 13, wherein the release layer comprises at least two different layers having different compositions.

20. The release liner according to claim 13, wherein the inductive filler material is arranged homogeneously to at least one of the layers of the release layer.

21. The release liner according to claim 13, wherein the inductive filler material is arranged non-homogeneously to at least one of the layers of the release layer.

22. The release liner according to claim 13, wherein the release agent is at least partly curable by electromagnetic induction heating of the inductive filler material.

23. The release liner according to claim 13, wherein the release agent is curable with one or more heating methods based on radiative or convective heating or combination of those.

24. The release liner according to claim 14, wherein the inhibitor is deactivatable simultaneously with or before the electromagnetic induction heating.

25. The release liner according to claim 24, wherein the inhibitor is deactivatable by using ultraviolet radiation.

25. The release liner according to claim 13, further comprising:
pressure sensitive label laminates.

26. A label laminate, comprising:
a face stock material;
an adhesive layer; and
a release liner with a release layer on a liner substrate, the release layer having a composition comprising at least a release agent and an inductive filler material, wherein the release agent is at least partly cured by electromagnetic induction heating.

27. The label laminate according to claim 26, wherein the inductive filler material comprises particles and/or fibers.

28. The label laminate according to claim 27, wherein size of the particles and/or fibers is in nanoscale.
